(19) United States
(12) Patent Application Publication
(10) Pub. No.: US 2015/0199652 A1
(43) Pub. Date: Jul. 16, 2015

(54) REAL-TIME COLLABORATIVE SCHEDULING BASED ON PROXIMITY

(71) Applicants: ROBIN ZUGER, USTER (CH); GREGORY BULLOCK, ZURICH (CH); DANIEL MICHAEL GREENBLATT, ZURICH (CH)

(72) Inventors: ROBIN ZUGER, USTER (CH); GREGORY BULLOCK, ZURICH (CH); DANIEL MICHAEL GREENBLATT, ZURICH (CH)

(21) Appl. No.: 13/673,619

(22) Filed: Nov. 9, 2012

(51) Int. Cl. G06Q 10/10; H04B 5/00; H04L 29/06

(52) U.S. Cl. CPC G06Q 10/1095; H04L 65/403; H04B 5/0025

(57) ABSTRACT

A system and method for collaborative, synchronous scheduling is disclosed. Computing devices within proximity of a host device may participate in a group synchronous communication session with the host to collaboratively schedule an event. A date and time may be proposed for the event. This date and time is transmitted to all devices in the group. A calendar on each device may show the proposed date and time. A conflicts check may be performed to determine if the proposed date and time conflicts with any other prior commitments already scheduled on the calendar. If there is a conflict, a new date and time may be proposed. When all group participant devices have agreed to and accepted a particular date and time for an event, one event is created that is shared on a calendar of each participant device.

### BACKGROUND

Scheduling events with family, friends, and colleagues can often be difficult given people's busy and demanding lives. In order to find an acceptable time to get together, a group of people must consult their calendars or digital datebooks so that they can recall the times and dates of their prior commitments. When one person in the group proposes a date and time for an event, each person in the group has to check his or her calendar to determine availability. Usually, multiple dates have to be proposed before a date and time is found that is suitable for everyone's schedule. Once the group chooses an acceptable date and time, each person typically needs to put the event on his or her own calendar. Not only is this process tedious, but the process also results in every person having an individual copy of the scheduled event. If the event needs to be modified or canceled, each person has to change or delete the event from his or her own calendar. Since each event is independently created, the event must be independently maintained. Alternatively, one person may create the event invitation using conventional scheduling programs, but that person has to invite each member of the group separately which can also be a tedious process. There should be an easy way to synchronize calendars when a group of people in close proximity to each other is collaboratively scheduling an event. Furthermore, there should be one copy of a group event that is sent to everyone's calendar so that if the event is updated or canceled, all of the event's invitees see modifications or cancellations.

### SUMMARY

This specification describes technologies relating to collaborative scheduling in general, and specifically to methods and systems for collaboratively scheduling group events when group participants are in close proximity to one another which results in the creation of group events that are shared across participants' multiple computer devices.

In general, one aspect of the subject matter described in this specification can be embodied in in a system and method for synchronous collaborative scheduling. An exemplary system includes: one or more processing devices and one or more storage devices storing instructions that, when executed by the one or more processing devices, cause the one or more processing devices to: establish a collaborative scheduling session between at least two computing devices based on proximity of the devices; transmit event scheduling data, including a proposed date and time, from one session participant device to each of the other participating devices; and responsive to participating devices accepting the event, creating the event on participating devices' calendars. An exemplary method includes automatically establishing a collaborative scheduling session between at least two computing devices based on proximity of the devices; transmitting event scheduling data, including a proposed date and time, from one session participant device to each of the other participating devices; and responsive to participating devices accepting the event, creating the event on participating devices' calendars. A second exemplary method includes joining a collaborative scheduling session with at least one computing device based on established proximity; receiving a group event request including a proposed date and time; responsive to one computing device declining the event, receiving a new proposed date and time for the event until a predefined percentage of computing devices accept the event; and responsive to the predefined percentage of computing devices accepting the event, creating the event.

These and other embodiments can optionally include one or more of the following features: proximity of the devices may be a physical distance between the devices; device proximity may be determined by near-field communication; device proximity may be determined by global positioning system; device proximity may be determined by a computer-implemented program which allows for synchronous communication; proximity of devices may be a virtual distance between devices.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram illustrating an exemplary computing device.

FIG. 2 is a block diagram illustrating actual, physical proximity of computing devices to a host computing device.

FIG. 3 is a block diagram illustrating virtual proximity of computing devices to a host computing device.

FIG. 4 is a flow diagram of an exemplary method for synchronous collaborative scheduling of an event when people are in real or virtual proximity with one another.

FIG. 5 is a block diagram illustrating an exemplary system for collaborative scheduling of an event when people are in real or virtual proximity with one another.

FIG. 6 is a flow diagram of an exemplary method for synchronous collaborative scheduling of an event when people are in real or virtual proximity with one another.

### DETAILED DESCRIPTION

According to an exemplary embodiment, a group of people can use computing devices to collaboratively schedule an event in real-time when the people are close in either real or virtual proximity. One person, the host, may use his or her computing device, a host device, to initiate a synchronous group session.

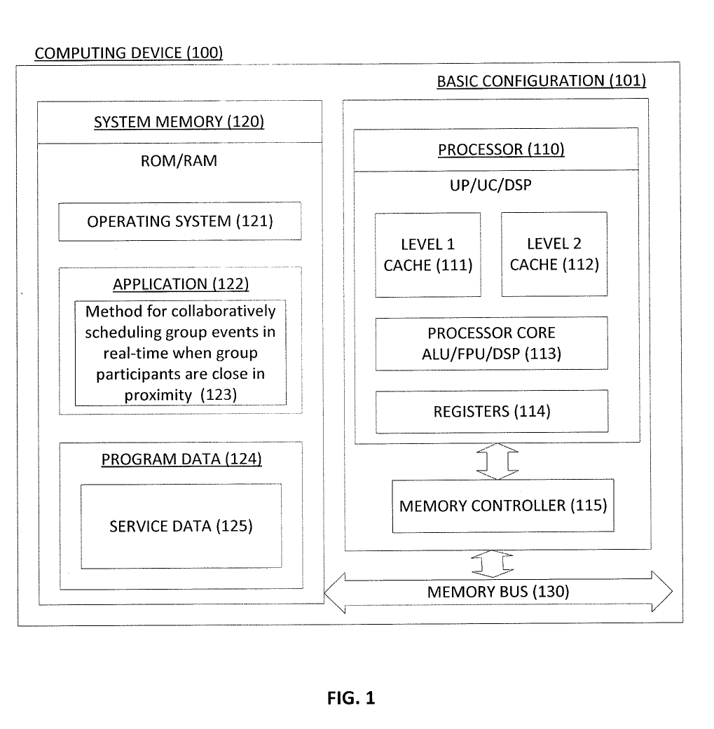

FIG. 1 is a block diagram illustrating an example computing device (100) that is arranged for initiating and participating in synchronous group sessions for collaborative scheduling. In a very basic configuration (101), the computing device (100) typically includes one or more processors (110) and system memory (120). A memory bus (130) can be used for communicating between the processor (110) and the system memory (120).

Depending on the desired configuration, the processor (110) can be of any type including but not limited to a microprocessor (μP), a microcontroller (μC), a digital signal processor (DSP), or any combination thereof. The processor (110) can include one more levels of caching, such as a level one cache (111) and a level two cache (112), a processor core (113), and registers (114). The processor core (113) can include an arithmetic logic unit (ALU), a floating point unit (FPU), a digital signal processing core (DSP Core), or any combination thereof. A memory controller (116) can also be used with the processor (110), or in some implementations the memory controller (115) can be an internal part of the processor (110).

Depending on the desired configuration, the system memory (120) can be of any type including but not limited to volatile memory (such as RAM), non-volatile memory (such as ROM, flash memory, etc.) or any combination thereof. System memory (120) typically includes an operating system (121), one or more applications (122), and program data (124). The application (122) may include a method for synchronous collaborative scheduling. Program Data (124) includes storing instructions that, when executed by the one or more processing devices, implement a system and method for collaboratively scheduling an event in real-time when the people and/or computing devices are close in either real or virtual proximity. (123). In some embodiments, the application (122) can be arranged to operate with program data (124) on an operating system (121).

The computing device (100) can have additional features or functionality, and additional interfaces to facilitate communications between the basic configuration (101) and any required devices and interfaces.

System memory (120) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media can be part of the device (100).

The computing device (100) can be implemented as a portion of a small-form factor portable (or mobile) electronic device such as a cell phone, a personal data assistant (PDA), a personal media player device, a wireless web-watch device, a personal headset device, an application-specific device, or a hybrid device that include any of the above functions. The computing device (100) can also be implemented as a personal computer including both laptop computer and non-laptop computer configurations.

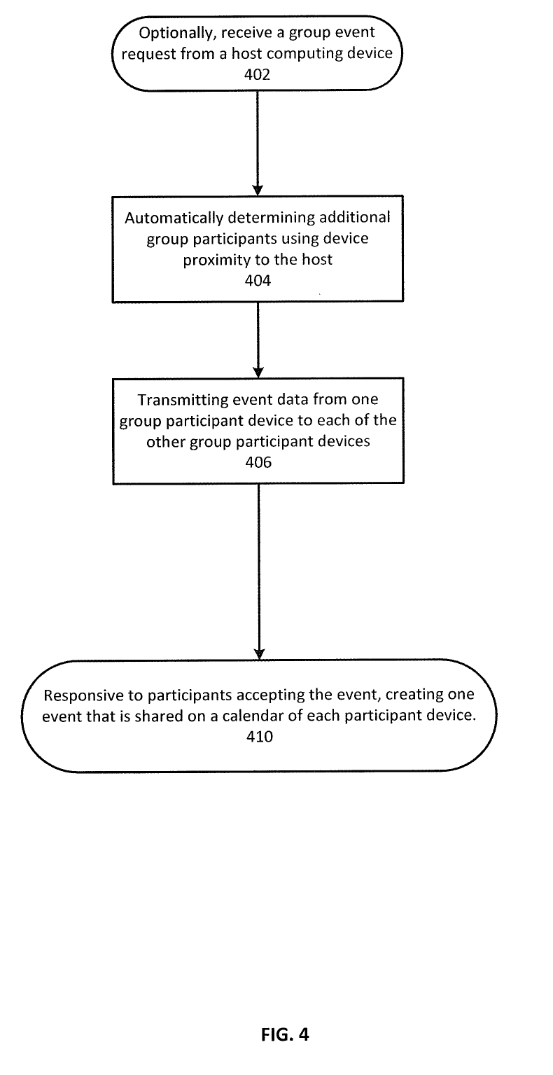

In order to initiate a synchronous group session, a host device may first create and transmit a request for a group event. An exemplary method, as depicted by FIG. 4, begins with receiving a group event request from a host computing device (402). Other group participant computing devices may be determined automatically using device proximity to the host (404).

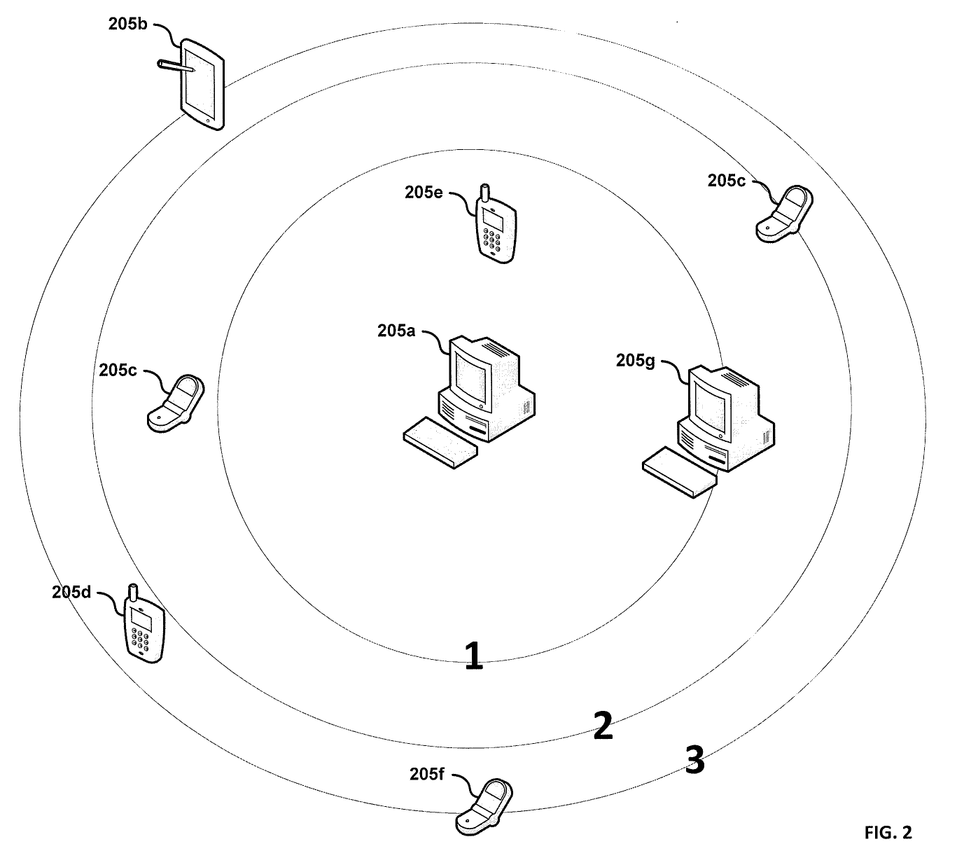

Proximity may be actual closeness of a device to the host device as illustrated in FIG. 2. In FIG. 2, computing device 205a may be a host device and other computing devices shown may be considered in close physical proximity to the host device. In some instances, only the computing devices within the radius of circle 1 may be considered in close proximity to computing device 205a. In other instances, all computing devices within the radius of circle 2 may be considered in close proximity to computing device 205a. In still other instances, computing devices within the radius of circle 3 may be considered in close proximity to computing device 205a. All radii shown in FIG. 2 are merely exemplary. Close proximity may be determined by any number of measurements of distance between a computing device and a host device.

Location technologies, including global positioning system (GPS), near field communication (NFC), and WiFi, may be used to determine this actual, physical proximity. GPS technology may locate all computing devices within a certain radius and establish a communication network among devices. NFC technology may allow computing devices that have either touched or which are in very close proximity, usually no more than a few centimeters, to establish a connection with one another. Computing devices on the same WiFi network can be located based on the location of the WiFi network.

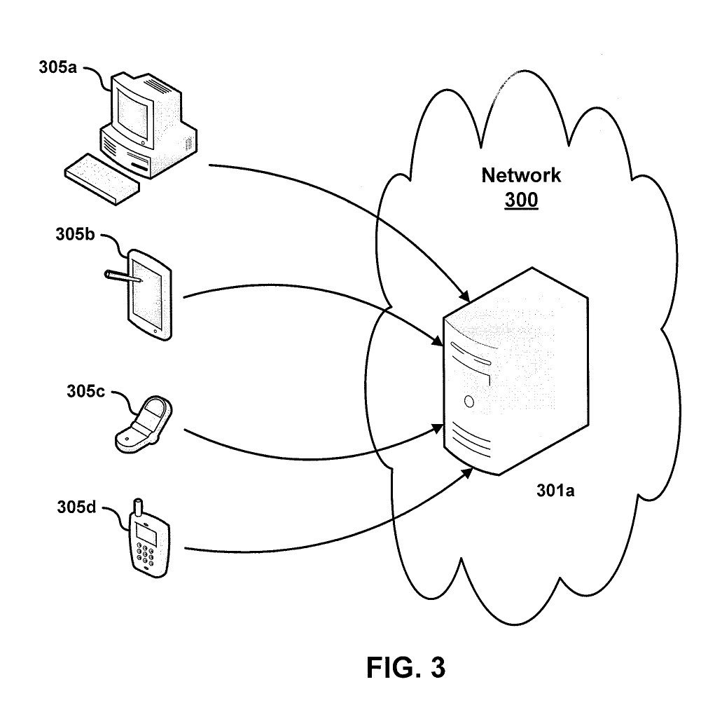

Proximity may alternatively be virtual closeness of a device to a host device, or a person to the host as illustrated in FIG. 3. In FIG. 3, computing device 301a may be a host device and all other devices shown are in close virtual proximity. This virtual proximity may be established by computer-implemented programs for conference calls or video teleconferencing such as Skype, Google Hangouts or Google Voice, and iChat. For example, a host device in a conference call may know the device ids of all of the other devices participating in the conference call. The host device may use the device ids to establish a group session for collaborative scheduling. In some instances, the device id of a person with whom a host would like to schedule an event are unknown and the person is not in close proximity. In these cases, a host may be able to use some other identifier such as email address, buddy list name, or skype handle to add the person via his or her computing device to a group session. Close virtual proximity may also be established by social graph, where people can be determined to be friends or friends of friends. Any computer-implemented program used to establish a connection among computing devices should be able to provide synchronous interaction.

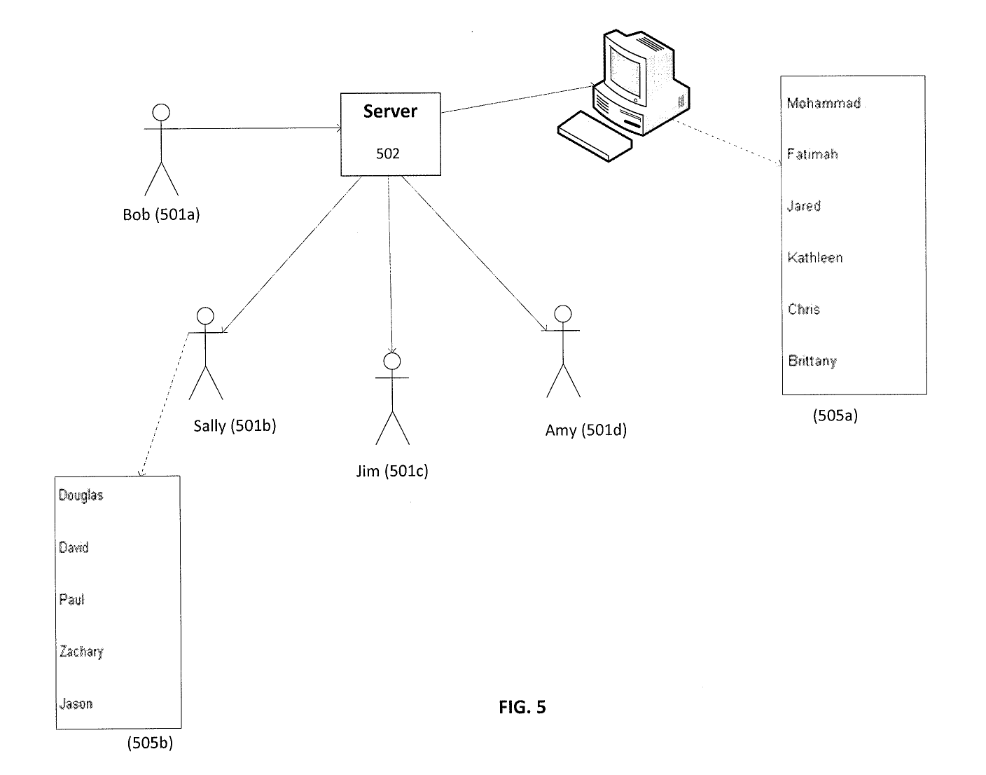

Although proximity to the host is used to initially establish group participation, a device associated with the group may then use proximity to invite more devices into the group. This device acts as a proxy host device to invite more people and/or devices which are either in actual or virtual proximity to the proxy host device. Virtual and actual proximity are established the same way for proxy hosts as they are for hosts. For example as illustrated in FIG. 5, a person, Bob, may use his computing device to request a group session to collaboratively schedule an event. Bob (501a) may then be connected to the devices of the people physically around him, including Sally (501b), Jim (501c), and Amy (510d). Bob (501a) may also be connected to people who are in virtual proximity to him, including people on his buddy list (505a). Sally (501b) may also want to add a person from her buddy list (505b) to the collaborative, synchronous scheduling session. To add someone from her buddy list (505b), Sally acts as a proxy host and adds the person to the session.

Alternatively to using a host device to establish a group session among people in close proximity, an exemplary embodiment may establish a group session when people and their computing devices are in close real or virtual proximity to one another and a calendar is being used on the device. In one embodiment, a group session may automatically be established when computing devices are in close real or virtual proximity to one another. In another embodiment, a group session may automatically be initiated, but people may be asked if they would like to join the group session before they are actually added to the session.

Once group participation has been established, data for an event, including a proposed date and time, may be transmitted from one group participant device to each of the other group participant devices as shown in FIG. 4 (406). Synchronous communication allows all group members to communicate with one another at the same time, in real-time. When a device receives the date and time information, a calendar on the device displays the proposed date and time. A conflicts check can be performed to determine if the proposed date and time conflicts with any other prior commitments already scheduled on the calendar. If there is a conflict, the device may notify the person who owns the device of the conflict. The person may also set the device to automatically accept or decline new events depending on certain criteria (maybe you always want to accept invites from your significant other or decline events from a certain acquaintance) regardless of conflicts.

If the person is notified of the conflict, the person may take one of several actions. The person could override the conflict and accept the proposed date and time even though the date conflicts with a prior commitment. The person could also manually find a new date and time to propose to the group. Alternatively, the person may allow the device to automatically propose a new date and time for the event. A newly proposed date and time that is found either manually by a person or automatically by a device may then be transmitted to all other group participant devices. If there is no conflict, a device may either automatically decline or accept the proposed date and time or wait for manual confirmation from the device owner before the proposed date and time is accepted or declined.

When group participant devices have agreed to and accepted a particular date and time for an event, one event is created that is shared on a calendar of each participant device (410). In one exemplary embodiment, a majority of devices may accept the particular date and time for the event. In another embodiment, a certain percentage of devices, which may be a predefined percentage, may accept before the event is created. Still another embodiment may require all devices to accept the event's date and time before the event is created.

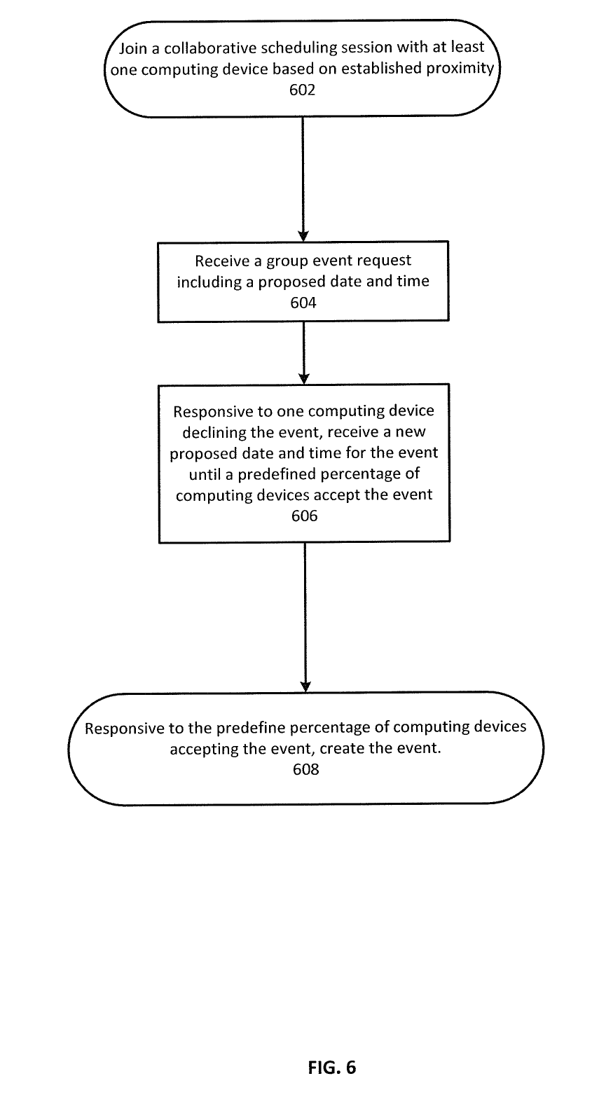

FIG. 6 illustrates an exemplary method for synchronous scheduling when there is a conflict. An exemplary method begins with computing devices joining a collaborative scheduling session with at least one other computing device based on established proximity (602). A group event request which includes a proposed date and time is then received (604). If one computing device has a conflict, a new date and/or time is proposed for the event (606). New dates and/or times may be proposed until some amount of computing devices accept the event (608).

One event is created across all devices so that if the event details need to be modified, the details can be modified on one device and the modifications will be sent to all other devices to update the event. If a group participant needs to update the event at a later time, the person has the option of sending an asynchronous modification request which can be accepted or declined by the other group participants. Alternatively, the group participant can initiate another group session in which all group members can participate in rescheduling the event in real-time. This group session for modifying an event may not search for group participants, but may use identifiers of the original group participants to establish a new session with the original group participants. Additional group members can be added via proximity to any of the original group participants using computer-implemented programs or location technologies discussed above. The participants can collaboratively choose a new date and time for an event as previously described.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for synchronous collaborative scheduling comprising:
automatically establishing a collaborative scheduling session between at least two computing devices based on proximity of the computing devices determined by near-field communication;
transmitting event scheduling data, including a proposed date and time, from one computing device to other computing devices; and
responsive to participating devices accepting the event, creating the event on computing devices' calendars.

2. (canceled)

3. (canceled)

4. (canceled)

5. (canceled)

6. (canceled)

7. A computer-implemented method for synchronous collaborative scheduling comprising:
joining a collaborative scheduling session with at least one computing device based on proximity determined by near-field communication;
receiving a group event request including a proposed date and time;
responsive to one computing device declining the event, receiving a new proposed date and time for the event until a predefined percentage of computing devices accept the event; and
responsive to the predefined percentage of computing devices accepting the event, creating the event.

8. (canceled)

9. (canceled)

10. (canceled)

11. (canceled)

12. (canceled)

13. A system for synchronous collaborative scheduling, the system comprising:
one or more processing devices; and
one or more storage devices storing instructions that, when executed by the one or more processing devices, cause the one or more processing devices to:
establish a collaborative scheduling session between at least two computing devices based on proximity of the computing devices determined by near-field communication;
transmit event scheduling data, including a proposed date and time, from one computing device to other computing devices; and
responsive to participating devices accepting the event, creating the event on computing devices' calendars.

14. (canceled)

15. (canceled)

16. (canceled)

17. (canceled)

18. (canceled)

19. A non-transitory computer readable medium having stored therein computer executable code that causes one or more processors to execute the steps of:
establishing a collaborative scheduling session between at least two computing devices based on proximity of the computing devices determined by near-field communication;
transmitting event scheduling data, including a proposed date and time, from one computing device to other computing devices; and
responsive to computing devices accepting the event, creating the event on computing devices' calendars.

20. (canceled)

21. (canceled)

22. (canceled)

23. (canceled)

24. (canceled)
